(19) United States
(12) Patent Application Publication
(10) Pub. No.: US 2015/0205459 A1
(43) Pub. Date: Jul. 23, 2015

(54) METHOD AND DEVICE FOR MANAGING FOLDER

(71) Applicant: Samsung Electronics Co., Ltd., Suwon-si (KR)

(72) Inventors: Dongwook KIM, Pohang-si (KR); Jungho HAN, Yongin-si (KR)

(21) Appl. No.: 14/600,297

(22) Filed: Jan. 20, 2015

(30) Foreign Application Priority Data
Jan. 20, 2014 (KR) 10-2014-0006887

(51) Int. Cl. G06F 3/0482; G06F 3/0486; G06F 3/0481

(52) U.S. Cl. CPC G06F 3/0482; G06F 3/04817; G06F 3/0486

(57) ABSTRACT

A method and a device for managing a folder are provided. The method includes detecting installation of an arbitrary application, displaying a folder selection interface for selecting a folder corresponding to the installed application, and when an arbitrary folder contained in the folder selection interface is selected, managing the installed application according to the selected folder. Therefore, according to the present disclosure, it is possible to effectively manage an application for each folder.

### CROSS-REFERENCE TO RELATED APPLICATION(S)

This application claims the benefit under 35 U.S.C. §119(a) of a Korean patent application filed on Jan. 20, 2014 in the Korean Intellectual Property Office and assigned Serial number 10-2014-0006887, the entire disclosure of which is hereby incorporated by reference.

### TECHNICAL FIELD

The present disclosure relates to an electronic device. More particularly, the present disclosure relates to a method and device for managing a folder of an electronic device.

### BACKGROUND

In recent years, electronic devices have been developed into multimedia devices capable of providing various additional services, such as an electronic organizer function, a game function, a schedule management function, and the like. As the electronic devices provide various additional services as described above, a user interface is indispensable which can more conveniently manage and use various types of additional services.

In addition, a variety of applications can be installed in electronic devices. Users manually arrange the installed applications according to folders using an editing function of the electronic devices.

In this case, if the users do not arrange the folders, the users cannot effectively manage the applications. Furthermore, a lot of time has to be spent on periodically arranging the folders.

Therefore, there is a need for studying a method of effectively managing applications.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and device for managing a folder of an electronic device.

Another aspect of the present disclosure is to provide a method and device which can install an application in an electronic device and then manage the application for each folder by displaying a folder list on a display unit of the electronic device.

In accordance with an aspect of the present disclosure, a method of managing a folder of an electronic device is provided. The method includes detecting installation of an arbitrary application, displaying a folder selection interface for selecting a folder corresponding to the installed application, and, when an arbitrary folder contained in the folder selection interface is selected, managing the installed application according to the selected folder.

In accordance with another aspect of the present disclosure, an electronic device is provided. The electronic device includes a display unit and a controller configured to detect installation of an arbitrary application, to display, through the display unit, a folder selection interface for selecting a folder corresponding to the installed application, and, when an arbitrary folder contained in the folder selection interface is selected, to manage the installed application according to the selected folder.

According to the present disclosure, when an application is installed or updated in an electronic device, a folder list is displayed. Therefore, a user can effectively manage an application for each folder.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to various embodiments of the present disclosure;

FIG. 2 is a block diagram of an electronic device according to various embodiments of the present disclosure;

FIG. 3 is a flowchart illustrating a process of managing an application for each folder according to various embodiments of the present disclosure;

FIGS. 4A and 4B illustrate interfaces for selecting a folder after installation of an application according to various embodiments of the present disclosure;

FIG. 5 is a flowchart illustrating a folder display operation, such as operation S330 of FIG. 3 according to an embodiment of the present disclosure;

FIG. 6 illustrates a user interface for configuring a folder display format according to an embodiment of the present disclosure;

FIG. 7 is a flowchart illustrating a folder display operation, such as operation S330 of FIG. 3 according to another embodiment of the present disclosure;

FIG. 8 is a flowchart illustrating a process of managing an application for each folder according to various embodiments of the present disclosure;

FIGS. 9A and 9B illustrate an example of selecting a folder through a folder selection interface when a plurality of applications is installed according to various embodiments of the present disclosure;

FIG. 10 is a flowchart illustrating a process of managing an application for each folder according to various embodiments of the present disclosure; and

FIG. 11 is a flowchart illustrating a process of managing an application for each folder according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the expression “include” or “may include” refers to the existence of a corresponding function, operation, or element, and does not exclude one or more additional functions, operations, or elements. Also, as used herein, the terms “include” and/or “have” should be construed to denote a certain feature, number, operation, element, component or a combination thereof, and should not be construed to exclude the existence or possible addition of one or more other features, numbers, operations, elements, components, or combinations thereof.

Also, as used here, the expression “or” includes any or all combinations of words enumerated together. For example, the expression “A or B” may include A, may include B, or may include both A and B.

In an embodiment of the present disclosure, the expressions “a first”, “a second”, “the first”, “the second”, and the like may modify various elements, but the corresponding elements are not limited by these expressions. For example, the above expressions do not limit the sequence and/or importance of the corresponding elements. The above expressions may be used merely for the purpose of distinguishing one element from the other elements. For example, a first user device and a second user device indicate different user devices although both of them are user devices. For example, a first element may be termed a second element, and similarly, a second element may be termed a first element without departing from the scope of the present disclosure.

When an element is referred to as being “coupled” or “connected” to any other element, it should be understood that not only the element may be directly coupled or connected to the other element, but also a third element may be interposed therebetween. Contrarily, when an element is referred to as being “directly coupled” or “directly connected” to any other element, it should be understood that no element is interposed therebetween.

The terms used in the following description are only used to describe various embodiments, and are not intended to limit the present disclosure.

Unless defined otherwise, all terms used herein, including technical and scientific terms, have the same meaning as those commonly understood by a person of ordinary skill in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure.

An electronic device according to the present disclosure may be a device including a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a MPEG Audio Layer 3 (MP3) player, a mobile medical device, a camera, a wearable device (for example, a Head-Mounted-Device (HMD) such as electronic glasses, electronic clothes, an electronic bracelet, an electronic necklace, an electronic accessory, an electronic tattoo, and a smart watch.

According to various embodiments of the present disclosure, an electronic device may be a smart home appliance with a communication function. The smart home appliances may include at least one of, for example, TeleVisions (TVs), Digital Video Disk (DVD) players, audio players, refrigerators, air conditioners, cleaners, ovens, microwaves, washing machines, air purifiers, set-top boxes, TV boxes (e.g., HomeSync™, Apple TV™, or Google TV™), game consoles, electronic dictionaries, electronic keys, camcorders, or electronic frames.

According to various embodiments of the present disclosure, the electronic device may include at least one of various medical devices (e.g., a Magnetic Resonance Angiography (MRA), a Magnetic Resonance Imaging (MRI), a Computed Tomography (CT) machine, and an ultrasonic machine), navigation devices, Global Positioning System (GPS) receivers, Event Data Recorders (EDR), Flight Data Recorders (FDR), vehicle infotainment devices, electronic devices for ships (e.g., navigation devices for ships, and gyro-compasses), avionics, security devices, automotive head units, robots for home or industry, Automatic Teller's Machines (ATMs) in banks, or Point Of Sales (POS) in shops.

According to another embodiment of the present disclosure, the electronic device may include at least one of furniture or a part of a building/structure having a communication function, electronic boards, electronic signature receiving devices, projectors, or various measuring equipment (e.g., equipment for measuring a water supply, an electricity, gases or radio waves). The electronic device according to the present disclosure may be a combination of one or more of the aforementioned various devices. Also, the electronic device according to the present disclosure may be a flexible device. Further, it is obvious to those skilled in the art that the electronic device according to the present disclosure is not limited to the aforementioned devices.

Hereinafter, an electronic device according to various embodiments of the present disclosure will be described with reference to the accompanying drawings. The term “user” used in various embodiments may refer to a person who uses an electronic device or a device (for example, an artificial intelligence electronic device) that uses an electronic device.

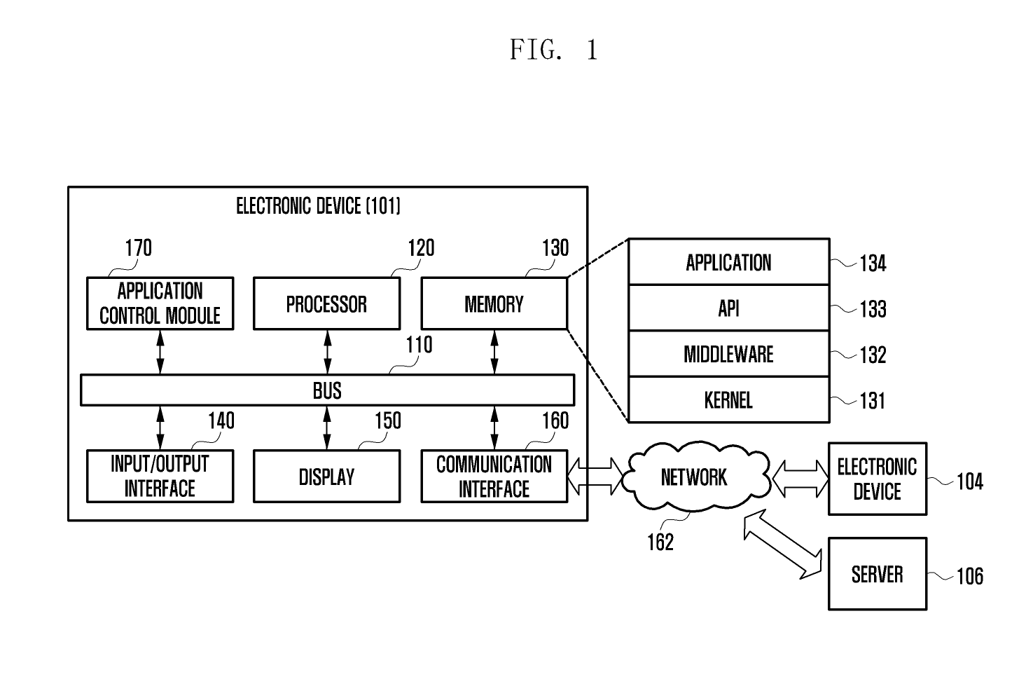

FIG. 1 illustrates a network environment including an electronic device according to various embodiments of the present disclosure.

Referring to FIG. 1, an electronic device 101 may include a bus 110, a processor 120, a memory 130, an input/output interface 140, a display 150, a communication interface 160, and an application control module 170.

The bus 110 may be a circuit connecting the aforementioned elements for transferring communication (e.g., a control message) between the aforementioned elements.

For example, the processor 120 (or controller) may receive instructions from other elements (e.g., the memory 130, the input/output interface 140, the display 150, the communication interface 160, and the application control module 170) through the bus 110, decipher the received instructions, and perform calculation or data processing according to the deciphered instructions.

In particular, the processor 120 according to an embodiment of the present disclosure, when an arbitrary application is installed, may display, through the display unit, a folder selection interface for selecting a folder corresponding to the installed application, and when an arbitrary folder contained in the folder selection interface is selected, may control a series of processes for managing the installed application according to the selected folder. In this case, according to various embodiments of the present disclosure, the processor 120 may display the folder selection interface after the arbitrary application is completely installed or before the installation of the arbitrary application.

The memory 130 may store instructions or data received from or created by the processor 120 or other elements (e.g., the input/output interface 140, the display 150, the communication interface 160, and the application control module 170). The memory 130 may include programming modules, for example, a kernel 131, middleware 132, an Application Programming Interface (API) 133, and applications 134. Each of the programming modules described above may be formed of software, firmware, and hardware, or a combination of at least two thereof.

The kernel 131 may control or manage system resources (e.g., the bus 110, the processor 120, the memory 130, etc.) used to execute operations or functions implemented by other programming modules, for example, the middleware 132, the API 133, and the application 134. In addition, the kernel 131 may provide an interface capable of accessing and controlling or managing the individual elements of the electronic device 101 by using the middleware 132, the API 133, or the application 134.

The middleware 132 may perform a relay function of allowing the API 133 or the applications 134 to exchange data by communicating with the kernel 131. Furthermore, in regard to task requests received from the applications 134, the middleware 132 may perform a control (e.g., scheduling or load balancing) for the task requests using, for example, a method of assigning a priority for using the system resources (e.g., the bus 110, the processor 120, and the memory 130) of the electronic device 101 to at least one of the applications 134.

The API 133 is an interface through which the applications 134 may control functions provided by the kernel 131 and the middleware 132, and may include at least one interface or function (e.g., instruction) for file control, window control, image processing, or text control, for example.

According to various embodiments of the present disclosure, the applications 134 may include a Short Message Service (SMS)/Multimedia Message Service (MMS) application, an e-mail application, a calendar application, an alarm application, a health care application (e.g., an application for measuring an amount of exercise or blood sugar), and an environmental information application (e.g., an application for providing an atmospheric pressure, humidity, temperature, and the like). Additionally or alternatively, the applications 134 may be related to an information exchange between the electronic device 101 and an external electronic device (e.g., an electronic device 104). The application related to the information exchange may include, for example, a notification relay application for transferring specific information to the external electronic device, or a device management application for managing the external electronic device.

For example, the notification relay application may include a function of transferring, to the external electronic device (e.g., the electronic device 104), notification information generated from other applications of the electronic device 101 (e.g., an SMS/MMS application, an e-mail application, a health management application, an environmental information application, and the like). Additionally or alternatively, the notification relay application may receive the notification information from, for example, the external electronic device (e.g., the electronic device 104), and may provide the received notification information to a user. The device management application may manage (e.g., install, delete, or update), for example, a function for at least a part of the external electronic device (e.g., the electronic device 104) communicating with the electronic device 101 (e.g., turning on/off the external electronic device itself (or some elements thereof) or adjusting brightness (or resolution) of a display), applications operating in the external electronic device, or services provided from the external electronic device (e.g., a telephone call service or a message service).

According to various embodiments of the present disclosure, the applications 134 may include an application designated depending upon an attribute (e.g., a type) of the external electronic device (e.g., the electronic device 104). For example, presuming the external electronic device is an MP3 player, the applications 134 may include an application related to reproduction of music. Similarly, in a case where the external electronic device is a mobile medical appliance, the applications 134 may include an application related to health care. According to an embodiment of the present disclosure, the applications 134 may include at least one of an application designated to the electronic device 101 and an application received from the external electronic device (e.g., a server 106 or the electronic device 104).

The input/output interface 140 may transfer instructions or data input from a user through an input/output device (e.g., the sensor 150, a keyboard, or a touch screen), to the processor 120, the memory 130, the communication interface 160, or the application control module 170 through, for example, the bus 110. For example, the input/output interface 140 may provide, to the processor 120, data for a user's touch input through the touch screen. Furthermore, through the input/output device (e.g., a speaker or a display), the input/output interface 140 may output instructions or data received from the processor 120, the memory 130, the communication interface 160, or the application control module 170 through the bus 110. For example, the input/output interface 140 may output voice data processed through the processor 120 to a user through a speaker.

The display 150 may display various types of information (e.g., multimedia data or text data) to a user.

The communication interface 160 may connect the electronic device 101 to the external electronic device (e.g., the electronic device 104 or the server 106). For example, the communication interface 160 may be connected to a network 162 through wireless or wired communication to communicate with the external device. The wireless communication may include at least one of, for example, Wireless Fidelity (Wi-Fi), BlueTooth (BT), Near Field Communication (NFC), GPS and cellular communication (for example, Long Term Evolution (LTE), LTE-Advanced (LTE-A), Code Division Multiple Access (CDMA), Wideband CDMA (WCDMA), Universal Mobile Telecommunication System (UMTS), Wireless Broadband (WiBro), Global System for Mobile communication (GSM), and the like). The wired communication may include at least one of, for example, a Universal Serial Bus (USB), a High Definition Multimedia Interface (HDMI), Recommended Standard 232 (RS-232), and a Plain Old Telephone Service (POTS).

According to an embodiment of the present disclosure, the network 162 may be a telecommunication network. The communication network may include at least one of a computer network, the Internet, the Internet of things, and a telephone network. According to an embodiment of the present disclosure, a protocol (e.g., a transport layer protocol, data link layer protocol, or a physical layer protocol) for communication between the electronic device 101 and the external device may be supported by at least one of the applications 134, the API 133, the middleware 132, the kernel 131, and the communication interface 160.

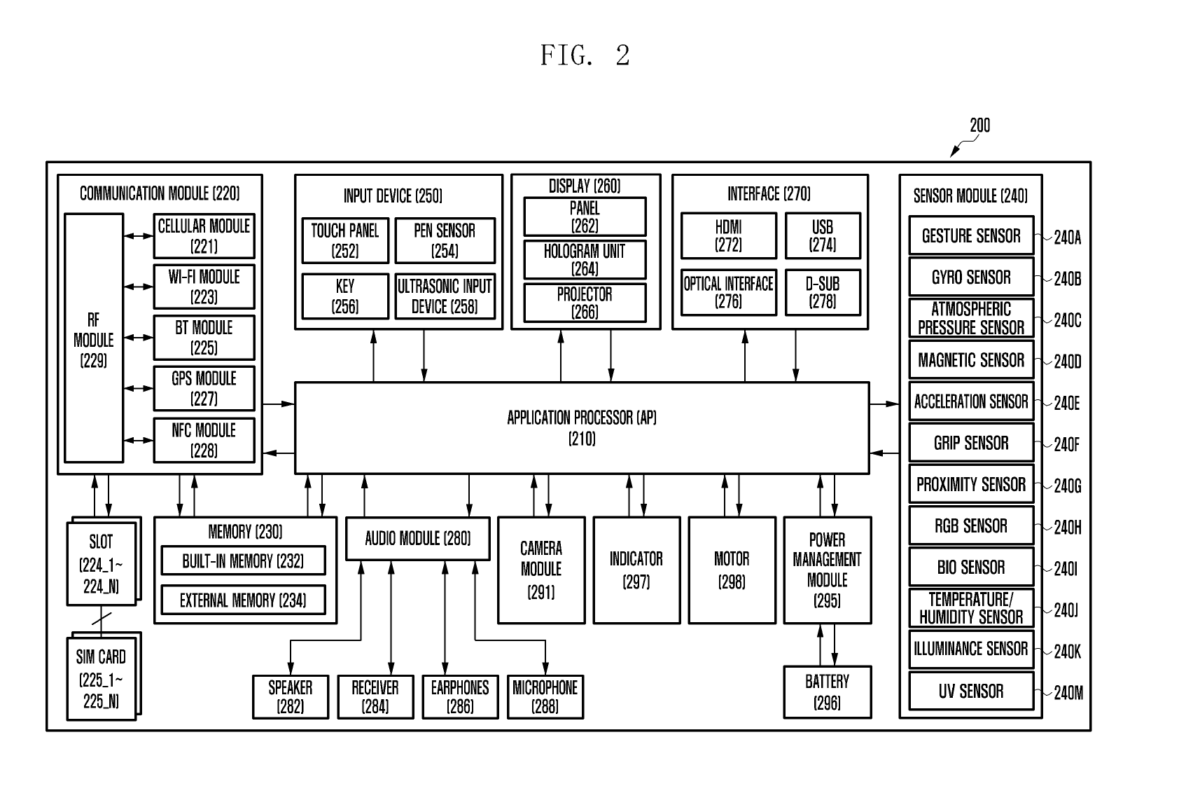

The application control module 170 may process information acquired from other elements (e.g., the processor 120, the memory 130, the input/output interface 140, and the communication interface 160), and may provide the processed information to a user through various methods. For example, the application control module 170 may recognize information associated with components included in the electronic device 101, store the information on the connection components in the memory 130, and execute the applications 134 based on the information on the connection components. Additional information on the application control module 170 will be provided through FIGS. 2 to 9, descriptions of which will be given below.

FIG. 2 is a block diagram of an electronic device according to various embodiments of the present disclosure.

Referring to FIG. 2, an electronic device 200 may include, all or some of the electronic device 101 illustrated in FIG. 1. Specifically, the electronic device 200 may include at least one Application Processor (AP) 210, a communication module 220, a Subscriber Identifier Module (SIM) card 225, a memory 230, a sensor module 240, an input device 250, a display 260, an interface 270, an audio module 280, a camera module 291, a power management module 295, a battery 296, an indicator 297, and a motor 298.

The AP 210 may control a plurality of hardware or software components connected to the AP 210 by driving an operating system or an application program and process various data including multimedia data and perform calculations. The AP 210 may be implemented by, for example, a System on Chip (SoC). According to an embodiment, the AP 210 may further include a Graphic Processing Unit (GPU, not illustrated).

The communication module 220 (e.g., the communication interface 160) may perform transmission/reception of data between the electronic device 200 (e.g., the electronic device 101) and other electronic devices (e.g., the electronic device 104 and the server 106) via a network. According to an embodiment, the communication module 220 may include a cellular module 221, a Wi-Fi module 223, a BT module 225, a GPS module 227, an NFC module 228, and a Radio Frequency (RF) module 229.

The cellular module 221 may provide a voice call, a video call, a SMS, or an Internet service through a communication network (e.g., LTE, LTE-A, CDMA, WCDMA, UMTS, WiBro, GSM, etc.). Furthermore, the cellular module 221 may distinguish and authenticate electronic devices within a communication network using, for example, a SIM (for example, the SIM card 225). According to an embodiment of the present disclosure, the cellular module 221 may perform at least some functions which can be provided by the AP 210. For example, the cellular module 221 may perform at least some of the multimedia control functions.

According to an embodiment, the cellular module 221 may include a Communication Processor (CP). Furthermore, the cellular module 221 may be implemented by, for example, an SoC. Although elements such as the cellular module 221 (e.g., a communication processor), the memory 230, and the power management module 295 are illustrated to be separate from the AP 210 in FIG. 2, the AP 210 may include at least some of elements (e.g., the cellular module 221) according to an embodiment of the present disclosure.

According to an embodiment of the present disclosure, the AP 210 or the cellular module 221 (e.g., communication processor) may load a command or data received from at least one of a non-volatile memory and other elements connected thereto in a volatile memory, and may process the loaded command or data. Furthermore, the AP 210 or the cellular module 221 may store data received from or generated by at least one of other elements in a non-volatile memory.

The Wi-Fi module 223, the BT module 225, the GPS module 227, and the NFC module 228 may include, for example, a processor for processing data transmitted/received through the corresponding module. Referring to FIG. 2, the cellular module 221, the WiFi module 223, the BT module 225, the GPS module 227, and the NFC module 228 are illustrated as separate blocks. However, according to an embodiment of the present disclosure, at least some (for example, two or more) of the cellular module 221, the WiFi module 223, the BT module 225, the GPS module 227, and the NFC module 228 may be included in one Integrated Circuit (IC) or one IC package. For example, at least some (for example, the communication processor corresponding to the cellular module 221 and the WiFi processor corresponding to the WiFi module 223) of the processors (e.g., the WiFi module 223, the BT module 225, the GPS module 227, and the NFC module 228, etc.) may be implemented by one SoC.

The RF module 229 may transmit/receive data, for example, an RF signal. Although not illustrated, the RF module 229 may include, for example, a transceiver, a Power Amplifier Module (PAM), a frequency filter, a Low Noise Amplifier (LNA) or the like. Furthermore, the RF module 229 may further include a component for transmitting/receiving electronic waves over a free air space, for example, a conductor, a conducting wire, or the like. The cellular module 221, the Wi-Fi module 223, the BT module 225, the GPS module 227, and the NFC module 228 share one RF module 229 in FIG. 2. However, according to an embodiment of the present disclosure, at least one of the cellular module 221, the Wi-Fi module 223, the BT module 225, the GPS module 227, or the NFC module 228 may transmit/receive an RF signal through a separate RF module.

The SIM cards 225_1˜N may be a card including a subscriber identification module and may be inserted into slots 224_1˜N formed in particular positions of the electronic device. The SIM cards 225_1˜N may include unique identification information (e.g., Integrated Circuit Card IDentifier (ICCID)) or subscriber information (e.g., International Mobile Subscriber Identity (IMSI).

The memory 230 (e.g., the memory 130) may include an internal memory 232 or an external memory 234. The internal memory 232 may include, for example, at least one of a volatile memory (e.g., a Random Access Memory (RAM), a Dynamic RAM (DRAM), a Static RAM (SRAM), a Synchronous Dynamic RAM (SDRAM), and the like), and a non-volatile Memory (e.g., a Read Only Memory (ROM) a One Time Programmable ROM (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, a Not OR (NOR) flash memory, and the like).

According to an embodiment of the present disclosure, the internal memory 232 may be a Solid State Drive (SSD). The external memory 234 may further include a flash drive, for example, a Compact Flash (CF), a Secure Digital (SD), a Micro Secure Digital (Micro-SD), a Mini Secure Digital (Mini-SD), an extreme Digital (xD), a memory stick, or the like. The external memory 234 may be functionally connected with the electronic device 200 through various interfaces. According to an embodiment of the present disclosure, the electronic device 200 may further include a storage device (or storage medium) such as a hard drive.

The sensor module 240 may measure a physical quantity or detect an operating state of the electronic device 200, and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, Red, Green, and Blue (RGB) sensor), a biometric sensor 240I, a temperature/humidity sensor 240J, an illumination sensor 240K, and a Ultra Violet (UV) sensor 240M. Additionally or alternatively, the sensor module 240 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), an InfraRed (IR) sensor, an iris sensor (not illustrated), a fingerprint sensor, and the like. The sensor module 240 may further include a control circuit for controlling one or more sensors included therein.

The input device 250 may include a touch panel 252, a (digital) pen sensor 254, a key 256, or an ultrasonic input device 258. The touch panel 252 may recognize a touch input through at least one of a capacitive type, a resistive type, an infrared type, and an acoustic wave type. The touch panel 252 may further include a control circuit. The capacitive type touch panel may recognize physical contact or proximity. The touch panel 252 may further include a tactile layer. In this case, the touch panel 252 may provide a tactile reaction to the user.

The (digital) pen sensor 254 may be implemented, for example, using a method identical or similar to receiving a touch input of the user, or using a separate recognition sheet. The key 256 may include, for example, a physical button, an optical key, or a keypad. The ultrasonic input device 258 may identify data by detecting an acoustic wave with a microphone (e.g., microphone 288) of the electronic device 200 through an input unit for generating an ultrasonic signal, and may perform wireless recognition. According to an embodiment of the present disclosure, the electronic device 200 may receive a user input from an external device (for example, computer or server) connected thereto using the communication module 220.

The display 260 (e.g., the display 150) may include a panel 262, a hologram device 264, or a projector 266. The panel 262 may be, for example, a Liquid Crystal Display (LCD) or an Active Matrix Organic Light Emitting Diode (AM-OLED). The panel 262 may be implemented to be, for example, flexible, transparent, or wearable. Together with the touch panel 252, the panel 262 may be configured as one module. The hologram device 264 may show a stereoscopic image in the air using interference of light. The projector 266 may project light onto a screen to display an image. The screen may be located, for example, inside or outside the electronic device 200. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature (D-sub) 278. The interface 270 may be included in, for example, the communication interface 160 illustrated in FIG. 1. Additionally or alternatively, the interface 270 may include, for example, a Mobile High-definition Link (MHL) interface, a SD card/Multi-Media Card (MMC) interface, or an Infrared Data Association (IrDA) standard interface.

The audio module 280 may bidirectionally convert a sound and an electrical signal. At least some elements of the audio module 280 may be included in, for example, the input/output interface 140 illustrated in FIG. 1. The audio module 280 may process sound information input or output through, for example, a speaker 282, a receiver 284, earphones 286, the microphone 288 or the like.

The camera module 291 is a device for capturing a still image or a moving image, and according to an embodiment of the present disclosure, may include one or more image sensors (e.g., a front sensor or a rear sensor), a lens (not illustrated), an Image Signal Processor (ISP) (not illustrated), or a flash (not illustrated) (e.g., a Light Emitting Diode (LED) or a xenon lamp).

The power management module 295 may manage power of the electronic device 200. Although not illustrated, the power management module 295 may include, for example, a Power Management Integrated Circuit (PMIC), a charger Integrated Circuit (IC), or a battery or fuel gauge.

The PMIC may be mounted to, for example, an integrated circuit or an SoC semiconductor. Charging methods may be classified into a wired charging method and a wireless charging method. The charger IC may charge a battery and prevent over voltage or over current from flowing from a charger. According to an embodiment of the present disclosure, the charger IC may include a charger IC for at least one of the wired charging method and the wireless charging method. A magnetic resonance type, a magnetic induction type, or an electromagnetic type may be exemplified as the wireless charging method, and an additional circuit for wireless charging, such as a coil loop circuit, a resonance circuit, a rectifier circuit, and the like may be added.

The battery gauge may measure, for example, a remaining quantity of the battery 296, or a voltage, a current, or a temperature during the charging. The battery 296 may store or generate electricity, and may supply power to the electronic device 200 using the stored or generated electricity. The battery 296 may include, for example, a rechargeable battery or a solar battery.

The indicator 297 may display a particular status, for example a booting status, a message status, a charging status, and the like, of the electronic device 200 or a part (e.g., the AP 210) of thereof. The motor 298 may convert an electrical signal to a mechanical vibration. Although not illustrated, the electronic device 200 may include a processing unit (e.g., GPU) for supporting a mobile TV. The processing unit for supporting the mobile TV may process media data according to a standard of Digital Multimedia Broadcasting (DMB), Digital Video Broadcasting (DVB), media flow or the like.

Each of the components of the electronic device according to the present disclosure may be implemented by one or more components and the name of the corresponding component may vary depending on a type of the electronic device. The hardware 200 according to an embodiment of the present disclosure may include at least one of the above-described elements. Some of the above-described elements may be omitted from the hardware 200, or the hardware 200 may further include additional elements. Further, some of the components of the electronic device according to the present disclosure may be combined to be one entity, which can perform the same functions as those of the components before the combination.

The term “module” used in the present disclosure may refer to, for example, a unit including one or more combinations of hardware, software, and firmware. The “module” may be interchangeably used with a term, such as unit, logic, logical block, component, or circuit. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

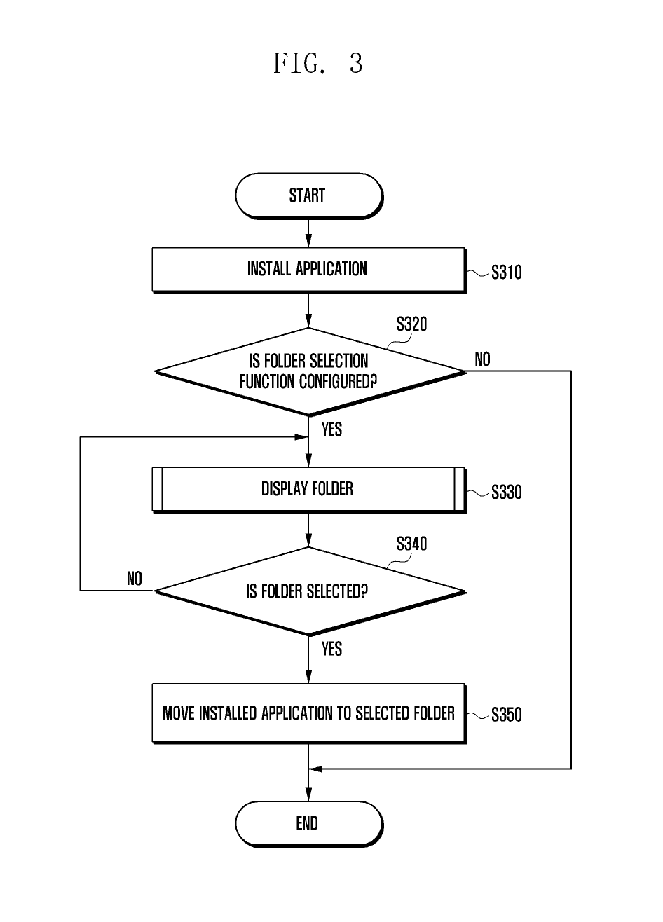

FIG. 3 is a flowchart illustrating a process of managing an application for each folder according to various embodiments of the present disclosure.

Referring to FIG. 3, first, in operation S310, an electronic device may detect that an arbitrary application has been installed. The electronic device may be connected to an arbitrary server through a wireless or wired interface to download an arbitrary application from the server and install the application. Alternatively, the electronic device may be connected to another electronic device, such as a PC, in a wireless or wired manner to receive an arbitrary application from the counterpart electronic device and install the application.

When the electronic device detects that the application has been completely installed, the electronic device determines whether a folder selection function has been configured, in operation S320.

When it is determined that the folder selection function has not been configured, the electronic device completes the installation of the application.

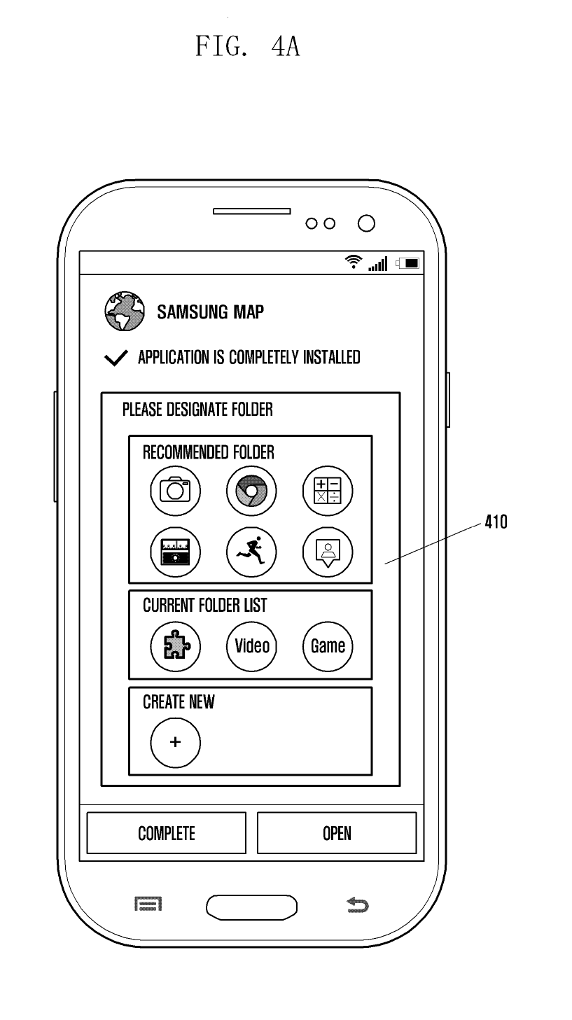

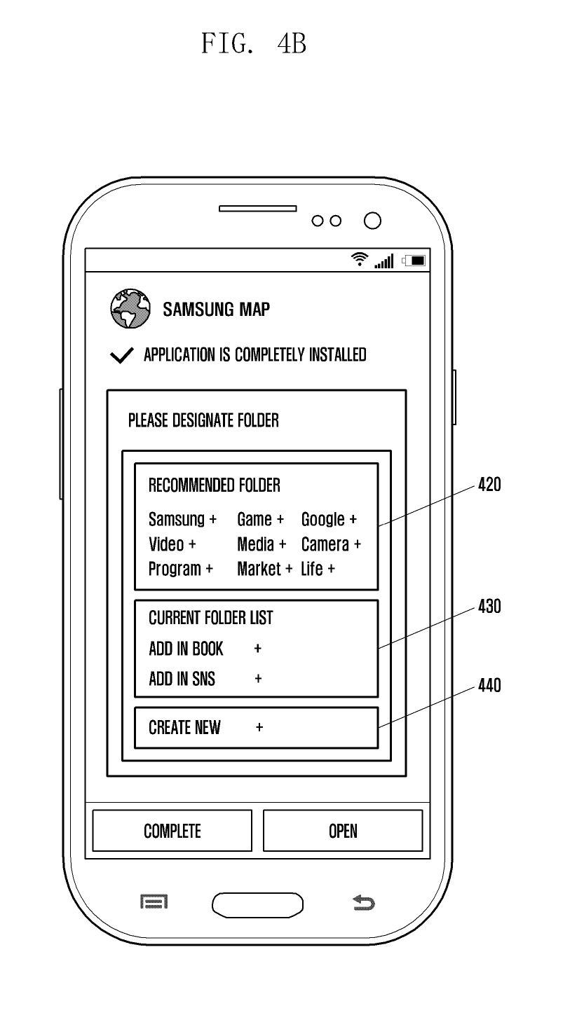

In contrast, when it is determined that the folder selection function has been configured, the electronic device proceeds to operation S330 to display, on a display unit, a screen for selecting a folder (a folder selection interface). This will be specifically described with reference to FIGS. 4A and 4B.

FIGS. 4A and 4B illustrate interfaces for selecting a folder after the installation of an application according to various embodiments of the present disclosure.

According to the various embodiments of the present disclosure, after an arbitrary application is installed in the electronic device, the electronic device may display an interface through which a folder corresponding to the installed application may be selected. In this case, the electronic device may display the folder in at least one icon format as indicated by reference numeral 410 or may display the folder in a text format.

Referring to FIG. 4A, an interface is displayed for selecting at least one folder icon.

Referring to FIG. 4B, an interface is displayed for selecting at least one folder in a text format. More specifically, referring to FIG. 4B, when an arbitrary application is installed, the electronic device may automatically recommend and display a folder corresponding to the installed application as indicated by reference numeral 420, display a folder list currently generated in the electronic device as indicated by reference numeral 430, or provide a menu 440 for generating a new folder.

The recommended folder may be a folder list determined as a default based on the operating system of the electronic device. For example, in the case of the Android® operating system, the folder list may include basically classified categories such as, for example, movie, game, life, finance, news, and the like. However, the present disclosure is not necessarily limited thereto.

Meanwhile, a folder corresponding to the application installed in the text format may be displayed as illustrated in FIG. 4B, in which case a recommended folder 420, a current folder list 430, and a Create New menu 440 are exemplified. The embodiment does not necessarily have to be limited only to FIG. 4B, and the same principle may also be applied to the interface of the icon format illustrated in FIG. 4A.

For example, in displaying the folder corresponding to the application installed in FIG. 4A, the recommended folder, the current folder list, and the Create New menu may also be differently displayed in the icon format.

Referring back to FIG. 3, after displaying the folder selection interface, the electronic device determines whether an arbitrary folder is selected by a user, in operation S340.

When the arbitrary folder is selected, the electronic device proceeds to operation S350 to move the installed application into the selected folder. That is, the electronic device manages the installed application based on the selected folder. For example, the installed application may be installed on an arbitrary folder of the electronic device, and the icon corresponding to the installed application may be managed while being included in the selected folder on the standby screen of the electronic device.

As described above, the present disclosure is provides that, when the arbitrary application is installed in the electronic device, the interface for selecting a folder to install the application is provided at the same time as completing the installation. Accordingly, the user can directly designate the folder for the installed application, thereby effectively managing various applications for each folder.

Although the embodiment in which the folder selection interface is displayed after the installation of the application has been described with reference to FIG. 3, the present disclosure is not necessarily limited thereto. For example, the folder selection interface may also be displayed immediately after a user input for installing an application is detected. In addition, after a user input for selecting a folder in the folder selection interface is completed, installation of an application may be initiated. Modified examples of the aforementioned embodiment may be applied to all embodiments which will be described below.

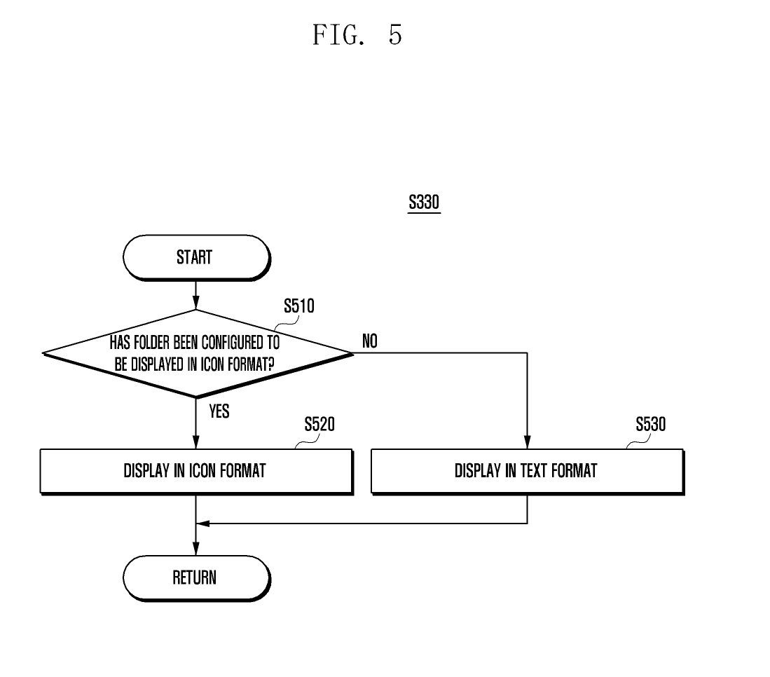

FIG. 5 is a flowchart illustrating a folder display operation, such as operation S330 of FIG. 3, according to an embodiment of the present disclosure.

Referring to FIG. 5, when displaying a screen for selecting a folder (a folder selection interface) after installing an application, the electronic device may determine whether the folder has been configured to be displayed in an icon format, in operation S510.

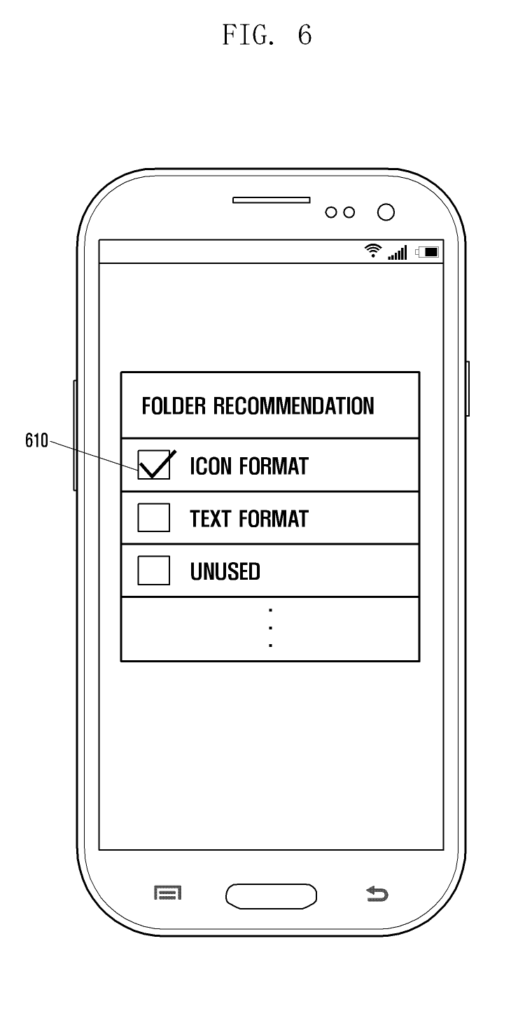

In this regard, the electronic device may provide a user with an interface in the format illustrated in FIG. 6 so as to configure the type of folder selection interface.

FIG. 6 illustrates a user interface for configuring a folder display format according to an embodiment of the present disclosure.

Referring to FIG. 6, the electronic device may provide check boxes corresponding to an icon format and a text format, respectively, to configure the type of the folder selection interface. Then, a user may input a check mark 610 in a check box to configure the type of folder selection interface. Referring to FIG. 6, the user may also configure to not display the folder selection interface.

Referring back to FIG. 5, when it is determined in operation S510 that the folder has been configured to be displayed in the icon format, the electronic device proceeds to operation S520 to display the folder selection interface in the icon format.

In contrast, when it is determined in operation S510 that the folder has not been configured to be displayed in the icon format, the electronic device may proceed to operation S530 and control to display the folder selection interface in the text format.

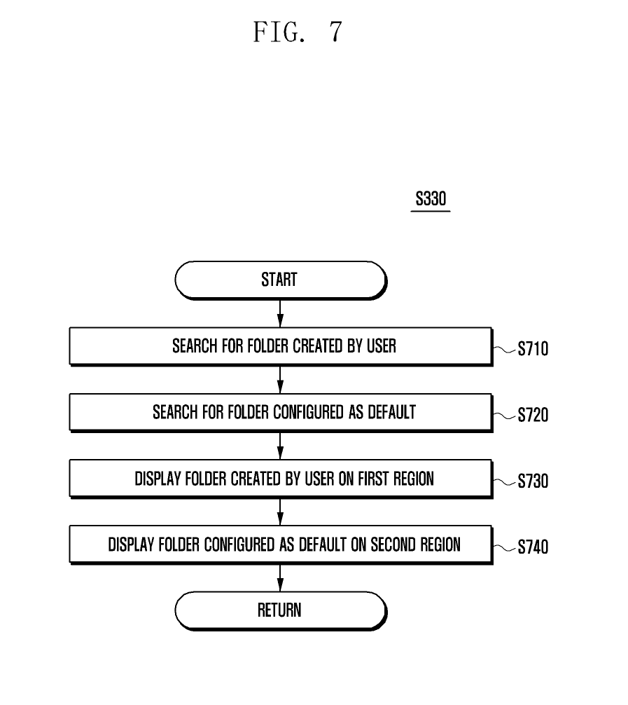

FIG. 7 is a flowchart illustrating a folder display operation, such as operation S330 of FIG. 3, according to another embodiment of the present disclosure.

Referring to FIG. 7, a flowchart illustrates operations of FIG. 4B in the case of displaying the folder selection interface according to the embodiment of the present disclosure.

When displaying a screen for selecting a folder (a folder selection interface) after installing an application, the electronic device may search for a folder created by a user, in operation S710.

The electronic device may identify (or search for) a folder configured as a default (i.e., a default folder), in operation S720. Here, the default folder may be a folder list determined in advance based on the operating system of the electronic device. For example, in the case of the Android® operating system, the folder list may include basically classified categories such as, for example, movie, game, life, finance, news, and the like. However, the present disclosure is not necessarily limited thereto.

In operation S730, the electronic device may display, on the first region, the folder created by the user. In operation S740, the electronic device may display, on the second region, the default folder.

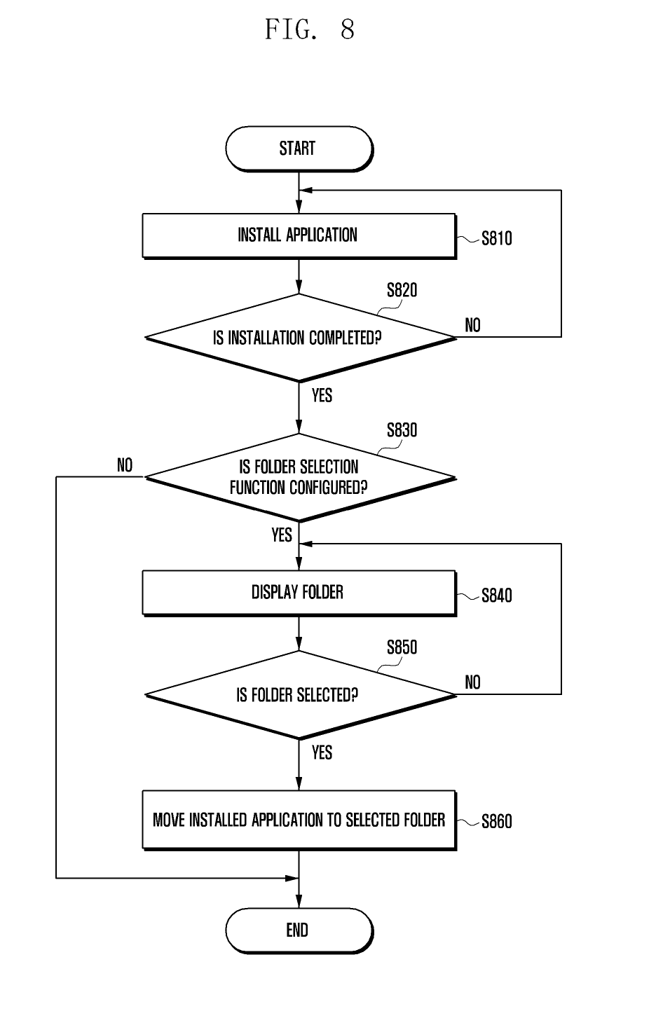

FIG. 8 is a flowchart illustrating a process of managing an application for each folder according to various embodiments of the present disclosure.

Referring to FIG. 8, a process is illustrated of managing an application for each folder when at least two applications are simultaneously installed.

First, in operation S810, the electronic device may detect that an arbitrary application has been installed. The electronic device having detected that the arbitrary application has been completely installed may proceed to operation S820 to determine whether all applications being currently installed have been completely installed.

When it is determined that all the applications have not been completely installed, the electronic device may return to operation S810 and install a next application.

When it is determined that all the applications have been completely installed in operations S820, the electronic device may proceed to operation S830 to determine whether the folder selection function of the present disclosure has been configured. When it is determined that the folder selection function has not been configured, the electronic device may determine the completion of the application installation.

In contrast, when it is determined that the folder selection function has been configured, the electronic device may proceed to operation S840 to display a folder selection interface. The specific characteristics that the electronic device selects for the folder selection interface have been described in operation S330 of FIG. 3, and therefore detailed descriptions will be omitted.

In operation S850, the electronic device determines whether an arbitrary folder is selected by a user.

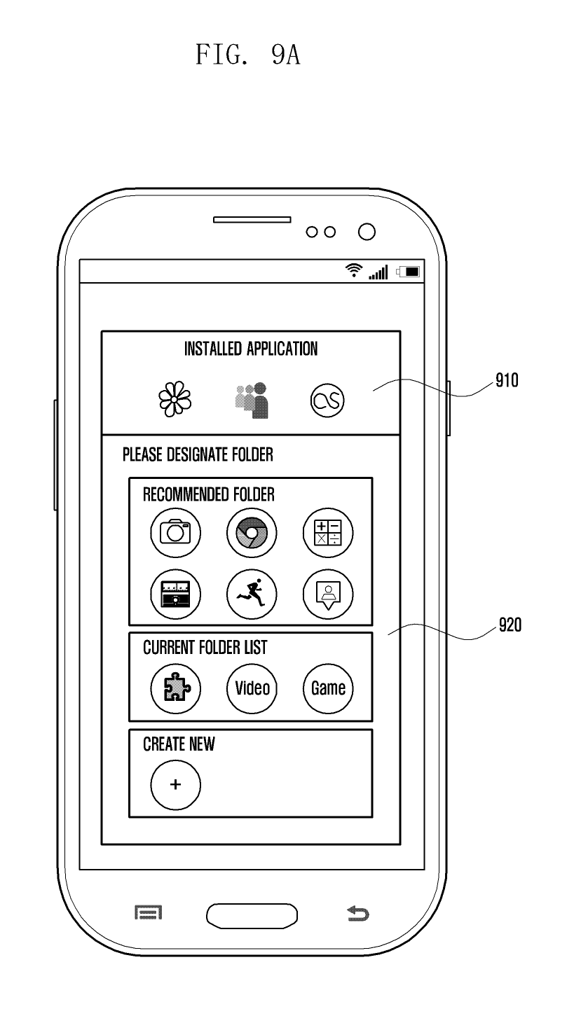

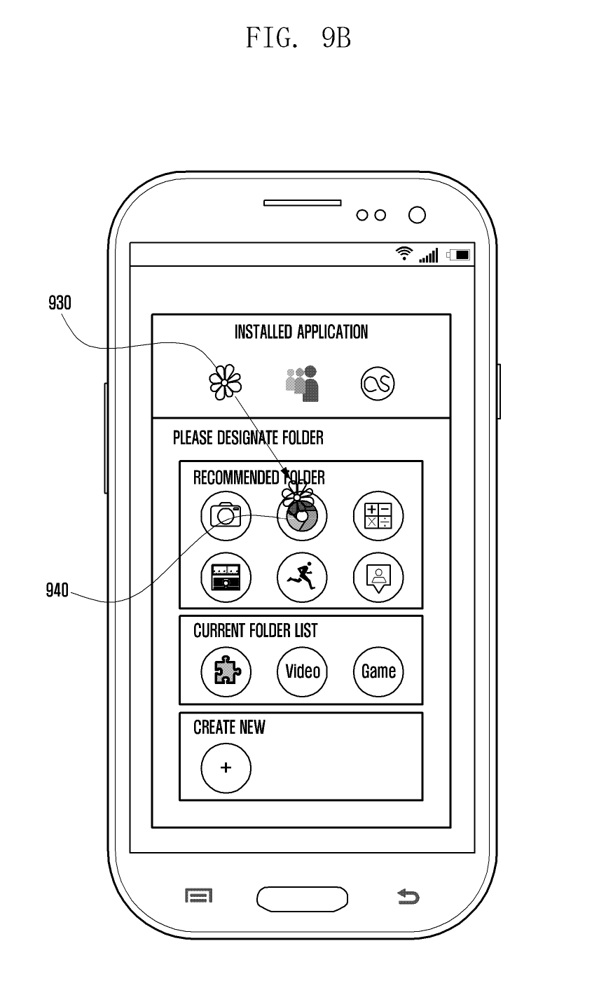

When a plurality of applications are installed, various embodiments in which a user selects a folder through a folder selection interface will be specifically described with reference to FIGS. 9A and 9B according to various embodiments of the present disclosure.

FIGS. 9A and 9B illustrate an example of selecting a folder through a folder selection interface when a plurality of applications is installed according to various embodiments of the present disclosure.

Referring to FIGS. 9A and 9B, a list of one or more applications installed in the electronic device for a particular time period may be displayed on an installed application region 910. The application list may be icons corresponding to the respective installed applications.

One or more folders may be displayed on a folder display region 920. As described above, a region for displaying recommended folders and a region for displaying a current folder list may be distinguishably displayed on the folder display region 920. Alternatively, at least one folder may also be displayed on one region.

A user may use a drag and drop input to select a folder corresponding to an installed application. For example, referring to FIG. 9B, the user may enter a selection input for selecting at least one application 930 displayed on the installed application region 910 and then, perform a drag and drop toward a folder 940 corresponding to the selected application. Then, the folder corresponding to the application 930 may be configured as the folder 940 corresponding to the location where the drag and drop input is entered.

When a plurality of applications is installed, the user may configure a folder corresponding to each of the installed applications using a drag and drop input in this way.

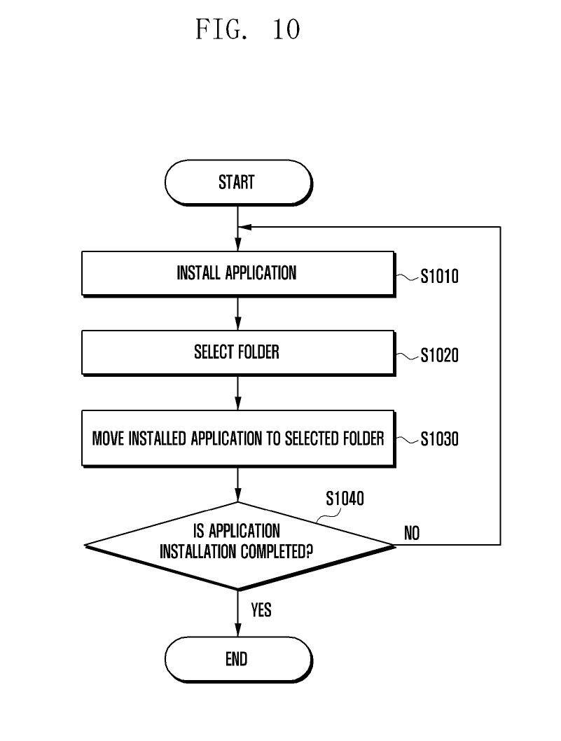

FIG. 10 is a flowchart illustrating a process of managing an application for each folder according to various embodiments of the present disclosure.

Referring to FIG. 10, another process is illustrated for managing an application for each folder when at least two applications are installed simultaneously.

First, in operation S1010, the electronic device may detect that an arbitrary application has been installed. Then, the electronic device may proceed to operation S1020 to control a series of processes for selecting a folder corresponding to the installed application through a folder selection interface. Since a specific description of operation S1020 has been already described above, a detailed description thereof will be omitted.

The electronic device may proceed to operation S1030 to move the installed application to the selected folder and manage the installed application.

Successively, the electronic device determines whether the installation of the application is completed, in operation S1040. When the installation is not completed, the electronic device may return to operation S1010 to control the process of installing another application and selecting a folder corresponding to the installed application.

As described above, when a plurality of applications are installed, every time an arbitrary application is completely installed, the electronic device may make a control to select a folder corresponding to the application. In addition, when folders are selected for all installed applications, respectively, the electronic device may terminate the corresponding function.

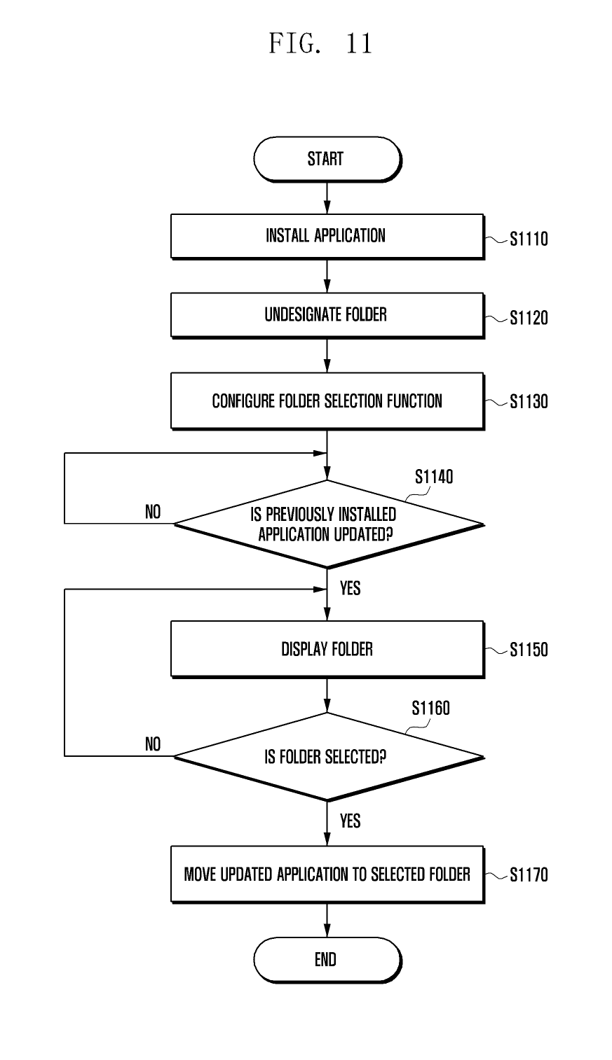

FIG. 11 is a flowchart illustrating a process of managing an application for each folder according to various embodiments of the present disclosure.

Referring to FIG. 11, a method is illustrated for managing an application for each folder when a folder selection function is configured after the application is installed.

First, in operation S1110, the electronic device may detect that an arbitrary application has been installed. It is assumed that a folder configuration function is configured as “unused” on the electronic device as in operation S1120 when the application is completely installed. Accordingly, the electronic device may not perform a separate folder selection process and may complete the installation of the application.

In operation S1130, the electronic device may detect that the folder selection function has been configured.

Thereafter, in operation S1140, the electronic device may determine whether the application already installed in the electronic device is updated.

When the application is updated, the electronic device may proceed to operation S1150 to display a folder selection interface.

In operation S1160, the electronic device may determine whether a folder corresponding to the updated application is selected. When the folder is not selected, the electronic device may return to operation S1150 to display the folder selection interface.

In contrast, when the folder is selected, the electronic device may proceed to operation S1170 to move the updated application to the selected folder and manage the application.

According to the above-described present disclosure, when an application is installed or updated in the electronic device, a folder list is displayed. Therefore, a user may effectively manage an application for each folder.

According to various embodiments of the present disclosure, at least some of the devices (for example, modules or functions thereof) or the method (for example, operations) according to the present disclosure may be implemented by a command stored in a computer-readable storage medium in a programming module form. When the command is executed by one or more processors (for example, the processor 210), the one or more processors may execute a function corresponding to the command. The computer-readable storage medium may be, for example, the memory 220. At least a part of the programming module may be implemented (for example, executed) by, for example, the processor 210. At least some of the programming modules may include, for example, a module, a program, a routine, a set of instructions or a process for performing one or more functions.

The computer readable recording medium may include magnetic media such as a hard disc, a floppy disc, and a magnetic tape, optical media such as a Compact Disc Read Only Memory (CD-ROM) and a DVD, magneto-optical media such as a floptical disk, and hardware devices specifically configured to store and execute program commands, such as a ROM, a RAM, and a flash memory. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of managing a folder of an electronic device, the method comprising:
when an arbitrary application is installed, displaying a folder selection interface for selecting a folder corresponding to the installed application; and
when an arbitrary folder contained in the folder selection interface is selected, managing the installed application according to the selected folder.

2. The method of claim 1, wherein the displaying of the folder selection interface comprises:
identifying whether a folder selection function is configured; and
displaying the folder selection interface when the folder selection function is configured.

3. The method of claim 1, wherein at least one folder contained in the folder selection interface is displayed in an icon format.

4. The method of claim 1, wherein at least one folder contained in the folder selection interface is displayed in a text format.

5. The method of claim 1, wherein the folder selection interface comprises:
a first region comprising at least one folder configured as a default; and
a second region comprising at least one folder created in the electronic device.

6. The method of claim 1, further comprising:
detecting an update for the arbitrary application installed in the electronic device.

7. The method of claim 1, wherein the selecting of the folder comprises:
when a plurality of applications is installed, selecting an icon corresponding to an arbitrary application among the installed applications; and
dragging and dropping the selected icon to a location corresponding to an arbitrary folder displayed in the folder selection interface.

8. The method of claim 1, wherein the displaying of the folder selection interface comprises:
when a plurality of applications is installed, displaying the folder selection interface after all of the plurality of applications are completely installed.

9. The method of claim 1, wherein the displaying of the folder selection interface comprises:
displaying the folder selection interface after the arbitrary application is completely installed.

10. The method of claim 1, wherein the displaying of the folder selection interface comprises:
displaying the folder selection interface before the installation of the arbitrary application is initiated.

11. An electronic device comprising:
a display unit; and
a controller configured to detect installation of an arbitrary application, to display, through the display unit, a folder selection interface for selecting a folder corresponding to the installed application, and, when an arbitrary folder contained in the folder selection interface is selected, to manage the installed application according to the selected folder.

12. The electronic device of claim 11, wherein the controller is further configured to identify whether a folder selection function is configured and display the folder selection interface when the folder selection function is configured.

13. The electronic device of claim 11, wherein at least one folder contained in the folder selection interface is displayed in an icon format.

14. The electronic device of claim 11, wherein at least one folder contained in the folder selection interface is displayed in a text format.

15. The electronic device of claim 11, wherein the controller is further configured to detect an update for the arbitrary application installed in the electronic device, to display, through the display unit, a folder selection interface for selecting a folder corresponding to the updated application, and, when an arbitrary folder contained in the folder selection interface is selected, to manage the installed application according to the selected folder.

16. The electronic device of claim 11, wherein, when a plurality of applications is installed, the controller is further configured to select an icon corresponding to an arbitrary application among the installed applications and drag and drop the selected icon to a location corresponding to an arbitrary folder displayed in the folder selection interface.

17. The electronic device of claim 11, wherein, when a plurality of applications is installed, the controller is further configured to control to display the folder selection interface after all of the plurality of applications are completely installed.

18. The electronic device of claim 11, wherein the folder selection interface comprises:
a first region comprising at least one folder configured as a default; and
a second region comprising at least one folder created in the electronic device.

19. The electronic device of claim 11, wherein the controller is further configured to display the folder selection interface after the arbitrary application is completely installed.

20. The electronic device of claim 11, wherein the controller is further configured to display the folder selection interface before the installation of the arbitrary application is initiated.
